(19) United States
(12) Patent Application Publication
(10) Pub. No.: US 2025/0010600 A1
(43) Pub. Date: Jan. 9, 2025

(54) Laminate Product and Method for Manufacturing a Laminate Product, Method for Processing a Laminate Product and Use of Corresponding Die-Cut Product, Computer-Readable Memory

(71) Applicant: Roberto SELOW, CURITIBA (BR)

(72) Inventor: Roberto SELOW, CURITIBA (BR)

(21) Appl. No.: 18/711,690

(22) PCT Filed: Dec. 7, 2021
(86) PCT No.: PCT/BR2021/050540

§ 371 Date: May 20, 2024

(51) Int. Cl. B32B 29/00; B32B 5/18; B32B 37/12; B32B 38/00

(52) U.S. Cl. CPC B32B 29/007; B32B 5/18; B32B 37/12; B32B 38/0004; B32B 2310/0843

(57) ABSTRACT

The present invention relates to a laminated product that comprises at least one first element (100) coupled to at least one second element (200) by means of at least one adhesion layer (300), wherein the first element (100) has a melting point temperature lower than the flash point temperature of the second element (200). The present invention also relates to a method for manufacturing a laminated product (10), a method for processing a laminated product (10) to obtain a cut product (500), the use of a cut product (500), and a computer-readable memory.

### FIELD OF APPLICATION

The present invention belongs to the field of printed, laminated and/or layered materials, comprising joining or molding a polymeric layer to other layers of other materials. The present invention also belongs to the field of printed and ornamental products, comprising books, notebooks, albums, binders, and decorative elements.

### INTRODUCTION

The present invention relates to a laminated product and a method for manufacturing a laminated product. The present invention also relates to a method for processing a laminated product to obtain a cut product and the use of the corresponding cut product.

### BACKGROUND

As already known, methods and processes for manufacturing laminated products and processing a laminated product to obtain a cut product often resort to artisanal or manual steps and processes, mainly when dealing with customized or personalized products such as photo albums, birthday cards, notebooks, scrapbooks, and various decorative elements.

Such procedures have as clear disadvantages and problems the expenditure of time, high cost of materials and tools, in addition to the limitations imposed by the skills of the craftsman or responsible user.

However, there have been several efforts in the state of the art to provide solutions that make it easier to obtain and personalize/customize these products and processes. Even so, these solutions often run into problems involving the use of dedicated printers, molds with few reuse possibilities, installations that are not very versatile, among others.

### PRIOR ART

There are several solutions in the prior art for obtaining a laminated product and final products comprising it. An example is seen in document U.S. Pat. No. 9,205,695 entitled “Scrapbook kit and method for creating a multi-layered visual image” which discloses a scrapbook page design kit formed to contain elements used to enable a method of creating a desired visual effect on a scrapbook page. This is done by providing a user with a selection of themes of associated templates.

The kit of U.S. Pat. No. 9,205,695 has a base surface designed to place at least two scrapbook working pages thereon, which are used to place the templates thereon and thus create the desired visual effect. The kit also has a top flap, coupled to a top edge of the base surface, having at least three pockets thereon for placing the boarder, accessory and picture templates separately therein.

Additionally, the kit of U.S. Pat. No. 9,205,695 has a right flap, coupled to a right edge of the base surface, having at least one pocket for placing a sheet of working paper therein, and a left flap, coupled to a left edge of the base surface, having at least one pocket for holding pictures selected to be placed on the scrapbook working page (as described in the document's abstract).

In U.S. Pat. No. 9,205,695, problems that are common in the relevant prior art are noted, mainly the use of inaccurate artisanal steps, as seen in its FIG. 12 and its method claim. It is also noted that the this solution aims to solve some of the problems of this field by using templates that facilitate the work of the end user, which generates other difficulties such as the storage of a variety of templates, their final costs, the lack of versatility of these templates, and their wear and tear overtime. Furthermore, this solution does not describe or suggest obtaining a product whose visual effect suggests three-dimensionality.

Another prior art solution is seen in document US 2003/0012454, entitled “Custom cut image products”, which discloses a method for obtaining custom cut image products by an unskilled common user/consumer, wherein the consumer identifies a subject within a digital image in a first location to produce a cut image product. A software program automatically differentiates the selected subject from the background. The consumer then places an order through a communication network with a production facility at a second location that is remote from the first location for producing a cut image product using the selected subject on a cut media sheet (as per the document abstract).

In US 2003/0012454, there is a concern to avoid having to resort to the artisanal steps or procedures already discussed. However, their solution results in more expensive processes and a more complex architecture, including dedicated printers and software, sending the image data to a second location remote from the first location. It is clear that the solution of US 2003/0012454 ends up obtaining more accurate and versatile results, compared to other solutions, but demands a much less versatile structure, which is more sophisticated and more expensive to implement and maintain. Furthermore, this solution also does not describe or suggest obtaining a product whose visual effect suggests three-dimensionality.

Other examples of the relevant prior art that demonstrate similar drawbacks are disclosed and described by patent documents US 2012/0215340, US 2011/0035038, US 2008/0213018, JPS6245490 and US 2016/0347114, among others. It is worth highlighting that such solutions depend on the use of a variety of printers, molds, suction devices to remove debris generated by cutting or burning and even cooling processes. The solutions provided by these documents are often vague regarding the treatment given to the base materials and their cuts, so that such processes and elements make these solutions more expensive, less versatile, slower and, as well as the others here treated, they neither describe nor suggest obtaining a product whose visual effect suggests three-dimensionality.

As can be inferred from the previous description, there is room for a solution capable of remedying the deficiencies of the state of the art. This means to say:
a. a laminated product whose visual effect suggests three-dimensionality;
b. a method for obtaining this laminated product that does not involve artisanal steps or complex manufacturing processes;
and
c. the use of this laminated product for various types of products, such as notebooks, decorative elements, among others.

### OBJECTS OF THE INVENTION

The object of the present invention is, therefore, to provide a laminated product according to the features of claim 1 of the attached set of claims.

Another object of the present invention is to provide a method for manufacturing laminated product according to the features of claim 4 of the attached set of claims.

Also another object of the present invention is to provide a method for processing a laminated product to obtain a cut product according to the characteristics of claim 5 of the attached set of claims.

Yet another object of the present invention is to provide a cut product according to the features of claim 14 of the attached set of claims.

Another object of the present invention is the use of a cut product according to the features of claim 15 of the attached set of claims.

Yet another object of the present invention is a computer-readable memory according to the features of claim 16 of the attached set of claims.

Additional features and details thereof are presented in the dependent claims.

### BRIEF DESCRIPTION OF THE DRAWINGS

For a better understanding and visualization of the subject matter of the present invention, it will be described now with reference to the attached figures, representing the obtained technical effect, wherein, schematically:

FIG. 1: shows a side view of a product element in accordance with the invention;

FIG. 2: shows an exploded side view of the laminated product of FIG. 1;

FIG. 3: shows a side view of the laminated product of FIG. 1, illustrating the lowering step of the first element;

FIG. 4: shows a side view of the laminated product of FIG. 1, illustrating the cutting step of the second element;

FIG. 5: shows a side view of only the first element after a lowering step, apart from the second element for detailing purposes;

FIG. 6: shows a side view of only the second element after a cutting step, separated from the first element for detailing purposes;

FIG. 7: shows a side view of the laminated product after the lowering and cutting steps;

FIG. 7a: shows a side view of the laminated product after the lowering and cutting steps;

FIG. 8: shows a partial top view of the laminated product during the step of lowering the first element, with a partially transparent representation of the equipment and the beam, indicating the line and the cutting path;

FIG. 9: shows a partial top view of the laminated product during the cutting step of the second element, with a partially transparent representation of the equipment and the beam, indicating the line and the cutting path;

FIG. 10: shows a side view of a cut laminated product obtained in accordance with the invention after the lowering and cutting steps; and

FIG. 11: shows a top view of a cut laminated product according to the invention, showing the visual effect of three-dimensionality.

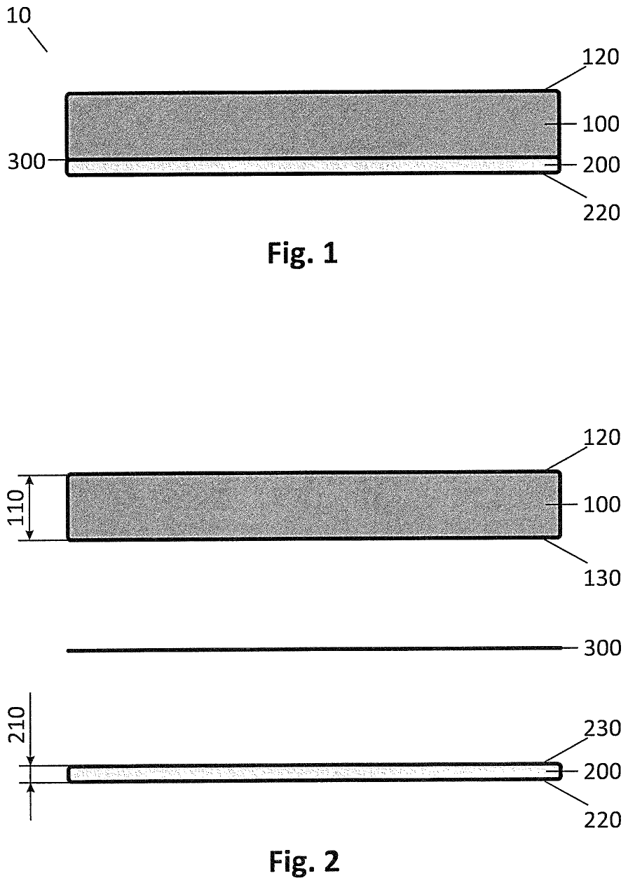

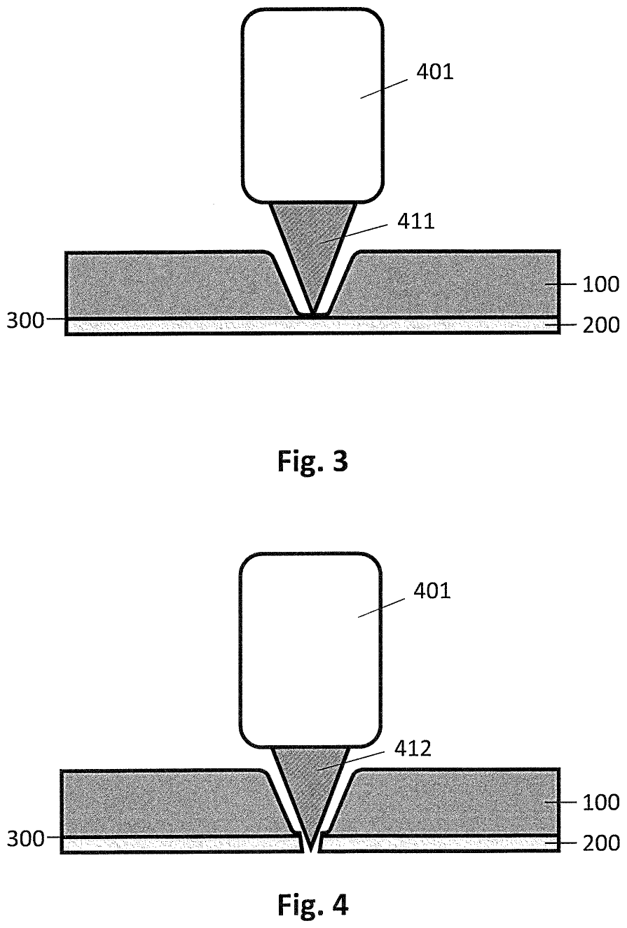

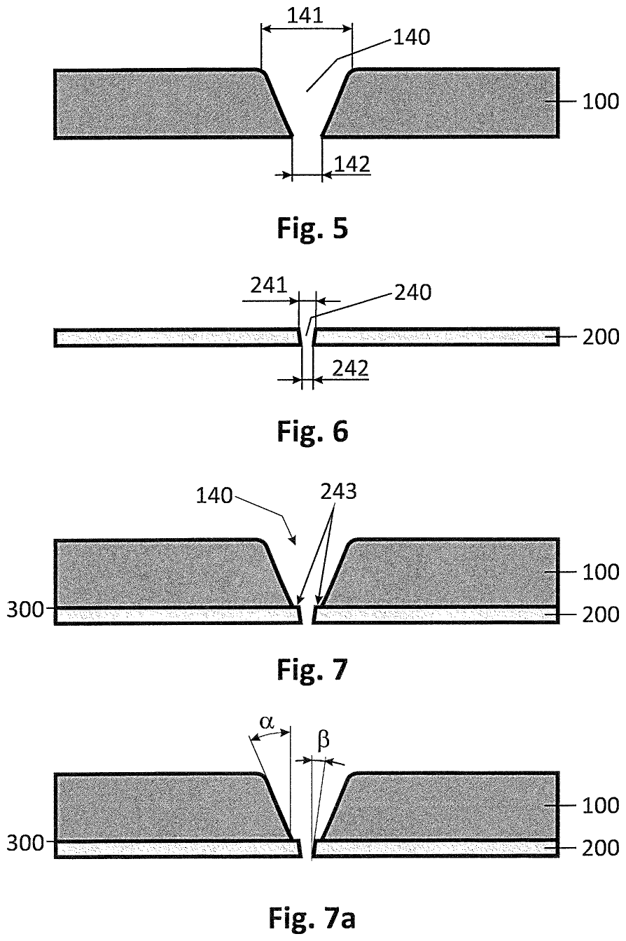

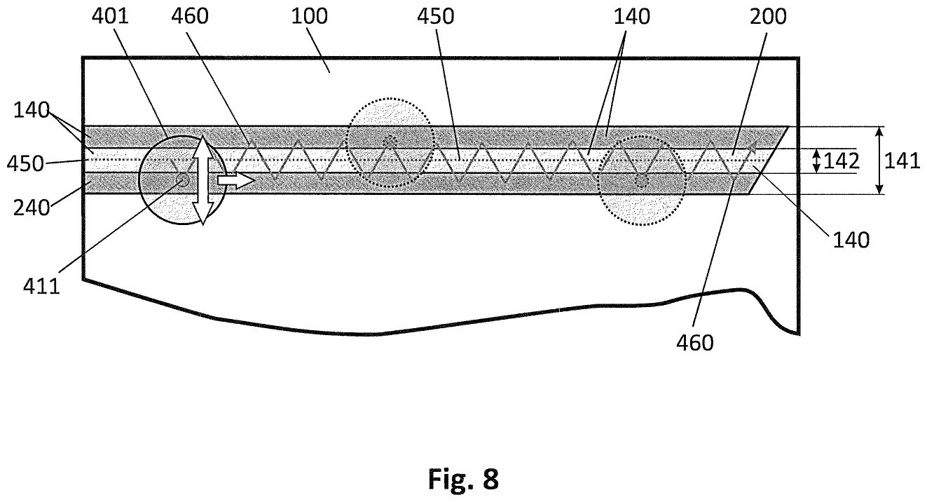

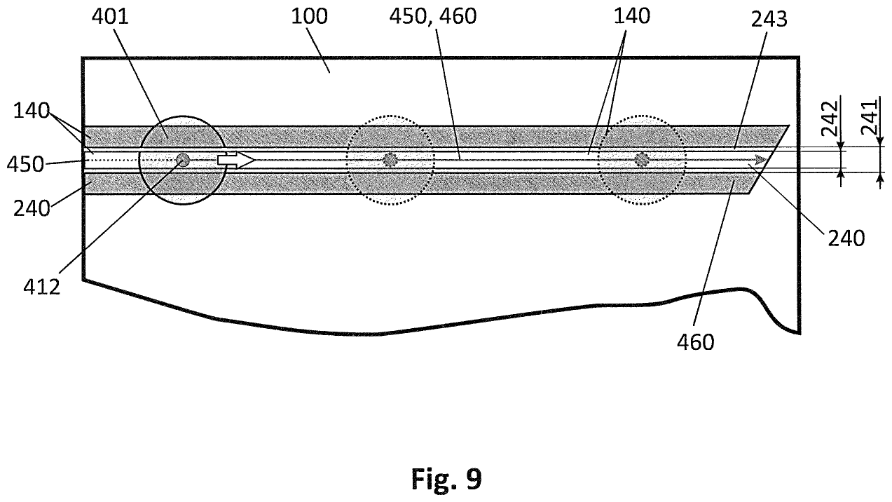

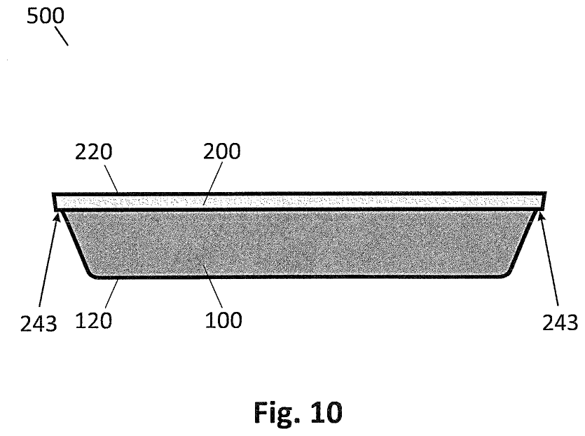

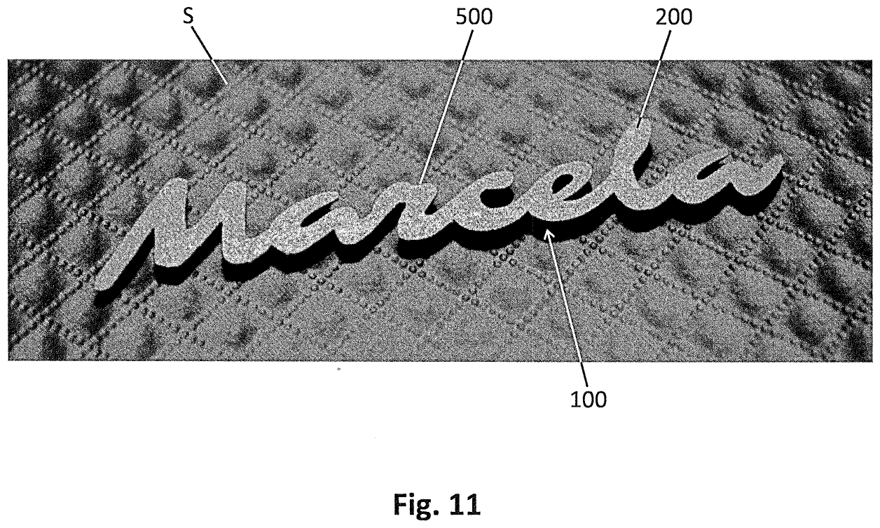

### DETAILED DESCRIPTION OF THE INVENTION

### Laminated Product

A laminated product (10), in accordance with the invention, is a product comprising at least two elements, a first element (100) is coupled to a second element (200) by means of at least one adhesion layer (300).

The elements (100, 200) of the laminated product (10) are made of materials with different physical-chemical features, in particular with different behaviors regarding temperature rise. Suitable indicators to characterize these behaviors are the melting point (the temperature at which a substance changes from a solid state to a liquid state) and the flash point (the minimum temperature necessary for a fuel to give off vapors or gases). Both points are measured on scales such as Celsius (° C.), Kelvin (K) and Fahrenheit (° F.). For the present invention, note that the first element (100) has a melting point temperature lower than the flash point temperature of the second element (200).

Another physical value capable of describing the difference between the elements materials (100, 200) is the thermal capacity, which is the relation between the heat amount provided to a body and the temperature variation observed in it, measured in SI in joules per kelvin (J/K), wherein therefore the heat capacity of the first element (100) must be lower than the heat capacity of the second element (200).

The material of the first element (100) must be chosen, in a non-limiting way, from the group of copolymers, especially from biphasic polymeric foams such as, for example, EVA (ethylene vinyl acetate) and the like, alone or in composite form together with other suitable materials, depending on the desired mechanical features, such as, for example, PP, HDPE, LLDPE, and LDPE, and the like.

The first element (100) can have any suitable shape, preferably, but not limited to, a flat laminar element, of first thickness (110) and provided with two parallel faces (120, 130), one is a free face (120) and the other one is a coupling face (130). The free face (120) may further comprise at least one adhesive layer, exposed or covered by a removable cover material.

The material of the second element (200) must be chosen, without limitation, from the group of cellulosic products, especially paper, paperboard, kraft paper, cardboard and other suitable similar products, plastics, etc. provided that it has a melting or flash point greater than that of the first element (100).

The second element (200) may have any suitable shape, preferably, but not limited to, a flat laminar element, of second thickness (210) and provided with two parallel faces (220, 230), one is a free or finishing face (220) and the other is a coupling face (230). The free or finishing face (220) may further comprise at least one additional decorative, functional, protective, coating layer and the like, and may also comprise one or more adhesive layers, any of the additional layers may be provided alone or together with others, exposed or covered by a removable covering material.

The adhesion layer (300) for coupling the elements (100, 200) is formed by an adhesive material and must be chosen from, preferably and not limited by, adhesives intended for bonding copolymers, especially biphasic polymeric foams such as, for example, EVA (ethylene vinyl acetate) and the like, and duplex and triplex card paper and the like, with a reserve area.

### Laminated Product Manufacturing Method

A manufacturing method in accordance with the invention is a method for manufacturing a laminated product (10) comprising a first element (100) coupled to a second element (200) by means of at least one adhesion layer (300), wherein the first element (100) has a melting point temperature lower than the flash point temperature of the second element (200).

The manufacturing method essentially comprises the following method steps:
i. Providing a first element (100) with a melting point temperature lower than the flash point temperature of the second element (200);
ii. Arranging an adhesion layer (300) on the coupling face (130) of the first element (100);
iii. Providing a second element (200) with a flash point temperature greater than the melting temperature of the first element (100);
iv. Arranging an adhesion layer (300) on the coupling face (230) of the second element (200);
v. Arranging the second element (200) on the first element (100); and
vi. Applying pressure on the assembly formed by the first element (100), adhesion layer(s) (300), and second element (200).

The arrangement of an adhesion layer (300) on the coupling face (130) of the first element (100) and/or on the coupling face (230) of the second element (200)—steps ii and iv—will depend on the specifications of the elements materials (100, 200), dimensions and use specifications of the laminated product (10), transport conditions, humidity, expected storage and/or shelf life (expiration), etc.

The pressure on the assembly formed by the first element (100), adhesion layer(s) (300) and second element (200) can be applied by any suitable means known from the state of the art, which may be by means of manual, mechanical, electrical, hydraulic, pneumatic presses and the like, including rollers and calenders and other means that can be applied to the used materials.

### Laminated Product Processing Method

A processing method in accordance with the invention is a method for processing a laminated product (10) comprising a first element (100) coupled to a second element (200) by means of at least one adhesion layer (300), wherein the first element (100) has a melting point temperature lower than the flash point temperature of the second element (200), the laminated product (10) having been manufactured by a method in accordance with the invention.

A processing method of the invention intends to provide one or more cut products (500) according to the design and cutting specifications of the desired part, following a corresponding drawing line or cutting line (450), which is known to be state of the art, derived from the output data of a graphic design tool and/or the like, obtained directly or through a suitable interface, in the form of an output signal capable of being read by a cutting equipment, preferably by a laser equipment (401) equipped with data processing devices, memory, with or without peripherals, and thus possibly alone and/or together with additional cutting instructions and/or specific to the equipment and/or informed by the user to the laser equipment (401), to guide the laser equipment (401) in order to perform the desired cut by performing a cutting path (460).

In the preferred and non-limiting embodiment of the present invention, the method comprises two steps performed with the same laser equipment (401), more specifically with the same optical assembly, comprising at least a first step of lowering the first element (100) and at least one second step of cutting the second element (200), being performed, preferably, but not limited to laser equipment (401) that use concentrated beams of light, wherein the lowering and cutting are preferably performed in the direction perpendicular to the plane of elements (100, 200), always from the first element (100) to the second element (200).

In the context of the present invention, lowering is understood as the considerable reduction in volume by sublimation and/or by melting and/or by melting and subsequently evaporating the material of the first element (100), through the thermal effect of the first laser beam (411) in the region of action, considering the above-mentioned melting point of the first element (100).

In the context of the present invention, cutting means the thermal separation by sublimation and/or by melting and/or by melting and subsequently evaporating the material of the second element (200), through the thermal effect of the second laser beam (412) on the region of operation, considering the above mentioned flash point of the second element (200).

In the first step, a first beam (411) oscillating along the path corresponding to the predetermined cutting line (450), combining a translation movement across the cutting line (450) with an oscillating or zigzag movement around the cutting line (450), with a first translation/oscillation speed and a first power of laser beam (411) combined so as to lower the first element (100) without cutting the second element (200).

In this way, a first conical channel or conical housing (140) is opened in the first element (100), which tapers from a first wider channel (141) on the free face (120) surface towards a first narrower channel (142), close to the second element (200) surface, wherein the walls of the first conical channel (140) form a first angle (α) with the vertical plane. The first angle (α) ranges between 1° and 70°, preferably between 10° and 60°, and more preferably between 15° and 45°.

The amplitude of the oscillation movements, which corresponds to the distance perpendicular to the cutting line (450) between two ends of the cutting path (460), must be adjusted according to the thermal features of the first material (100), and must always be smaller than the measurements of the first conical channel (140).

In the second step, a second beam (412) preferably travels linearly along the path corresponding to the predetermined cutting line (450), in a translation movement across the cutting line (450) and that coincides with the cutting path (460), and thus in the center of the first conical channel (140), with a second translation speed and a second laser beam power, combined in order to cut the second element (200). In this way, a second conical channel or conical housing (240) opens in the second element (200) which tapers from a second wider channel (241) on the surface of the coupling face (230) to a second narrower channel (242) close to the free face (220), wherein the second conical channel (240) forms a second angle (β) with the vertical plane. The second angle (β) may be equal or different, preferably smaller than the first angle (α), the second angle (β) may even be equal to 0°.

It should be noted that, depending on the features of the material of the adhesion layer (300), the speed and power of the first beam (411), the adhesion layer (300) can be cut or lowered or removed in both the first and second steps, and may still be partially removed from the cutting region in the first step and completely removed in the second step.

The power of the first beam (411) of the first step must always be lower than the power of the second beam (412) of the second step, whereas the translation speed of the second beam (412) of the second step must be lower than the translation speed of the first beam (411) of the first step. The ideal relationship is established when the power of the first beam (411) corresponds to a value between 30% and 70%, preferably between 40% and 60%, more preferably to a value of 50% of the power of the second beam (412), and when the speed of the second beam (412) corresponds to a value between 30% and 70%, preferably between 40% and 60%, more preferably to a value of 50% of the speed of the first beam (411).

As it advantageously deals with the same optical group, the width of the second beam (412) will be equal to the width of the first beam (411), however having a sufficiently high power to promote the integral cut of the laminated product (10), remembering that the second element (200) has thermal characteristics distinct from those of the first element (100).

It should be noted that the first step may be sequentially repeated as many times as necessary to promote lowering the first element (100). Similarly, the second step may be sequentially repeated as many times as necessary to cut the second element (200). Finally, it is also important to point out that the first step may be sequentially or alternately repeated with the second step, that is, it is possible to perform one or more steps with translational movement combined with oscillatory movement and/or one or more steps with simple translational movement.

In a non-limiting embodiment of the present invention, the lowering and cutting are performed with the same beam (411).

In another non-limiting embodiment of the present invention, the lowering and cutting steps are performed by traversing in an oscillating way the path that corresponds to the cutting line (450), combining translation movement across the cutting line (450) with an oscillating or zigzag movement around the cutting line (450).

In yet another non-limiting embodiment of the present invention, the lowering and cutting steps are performed linearly by traversing the path that corresponds to the cutting line (450), in a translation movement across the cutting line (450) and that coincides with the cutting path (460).

In another non-limiting embodiment of the present invention, the laser processing is carried out in two steps, however the first step is performed with the first laser beam (411) with only a translation movement across the cutting line (450), this embodiment may be performed with the same laser equipment (401) or the same optical assembly or with an optical assembly for each step.

In still another non-limiting embodiment of the present invention, laser cutting is performed in a single step, with laser power (401) sufficient to promote the lowering of the first element (100) and the cutting of the second element (200) simultaneously, by means of a single beam with an angulation capable of resulting in a first narrowest channel (142) greater than the width of the second narrowest channel (242), forming the edge (243), providing an angle (α) to the first element (100) and an angle (β) to the second element (200) which, in this embodiment, will be equal. The widths of the conical housing (140, 240) will be different since the first element (100) has a melting point temperature lower than the flash point temperature of the second element (200).

### Cut Product (500)

A cut product (500) in accordance with the invention is obtained by means of a method for processing a laminated product (10).

### Use of Cut Product (500)

The use in accordance with the invention is the use of a cut product (500) of the invention in decorative objects, collage, crafts, books, notebooks, albums, binders, furniture industries, textiles.

### Computer-Readable Memory

A computer-readable memory in accordance with the invention comprises a set of instructions which, when executed, carry out the method in accordance with the invention.

### Final Remarks

The present invention provides, in a novel and inventive way, a three-dimensional visual effect arising from the selection of elements (100, 200) with materials of different thermal characteristics, the relation between power and speed of the laser (401) between the steps, in the case of the two steps method, from providing an angle (α) to the first element (100) different from 0°, together with the execution of lowering and cutting that result in a first narrower channel (142) greater than the width of the second narrower channel (242), forming an edge (243).

Respecting the above conditions, the greater the difference between the first thickness (110) and the second thickness (210), the better the three-dimensional visual effect of the laminated product in relation to the substrate (S). Practical tests have proven that, in order to obtain the ideal three-dimensional visual effect, the thickness of the first element (100) must be 2 to 16 times, preferably 4 to 8 times, the thickness of the second element (200).

It is clear that the measures and relations between measures described for the present invention may vary according to the dimensioning of the laminated product (10). Exhaustive practical tests, however, demonstrated that the referred dimensions and their relations are highly efficient and effective for the reliability and safety provided by the laminated product (10) and its respective method.

### CONCLUSION

It will be easily understood by one skilled in the art that modifications may be made to the present invention without departing from the concepts set out in the description above. Such modifications should be considered as included within the scope of the present invention. Consequently, the particular embodiments previously described in detail are merely illustrative and exemplary, and not limitative in terms of the scope of the present invention, to which the full extent of the accompanying claims should be given, in addition to all and any equivalents thereof.

1. A laminated product, wherein said product comprises at least one first element coupled to at least one second element by means of at least one adhesion layer, wherein the first element has a lower melting point temperature than the flash point temperature of the second element.

2. The laminated product according to claim 1, wherein the first element is flat laminar, of first thickness, and provided with two parallel faces, one being a free face and the other one being a coupling face.

3. The laminated product according to claim 1, wherein the second element is flat laminar, of second thickness, and provided with two parallel faces, one being a free or finishing face and the other one being a coupling face.

4. A laminated product manufacturing method, wherein the method is for the manufacture of a laminated product defined in claim 1, wherein the method comprises the following method steps:
i) providing a first element with a melting point temperature lower than the flash point temperature of a second element;
ii) arranging an adhesion layer on the coupling face of the first element;
iii) providing a second element with a flash point temperature greater than the melting temperature of the first element;
iv) arranging an adhesion layer on the coupling face of the second element;
v) arranging the second element on the first element; and
vi) applying pressure on the assembly formed by the first element, adhesion layer(s), and second element.

5. A laminated product processing method for processing a laminated product defined in claim 1 to obtain a cut product, wherein the method comprises at least a first step of lowering the first element and at least a second step of cutting the second element, performed with the same laser equipment.

6. The laminated product processing method according to claim 5, wherein the method provides one or more cut products following a drawing line or cutting line, derived from output data in the form of an output signal readable by a laser equipment in order to perform the desired cut following a cutting path.

7. The laminated product processing method according to claim 5, wherein in the first step a first beam travels along the cutting line combining a translation movement across the cutting line with an oscillating or zigzag movement around the cutting line, with a first translation/oscillation speed and a first laser beam power, combined so as to lower the first element without cutting the second element.

8. The laminated product processing method according to claim 5, wherein in the first step a first conical channel or conical housing is opened in the first element, which tapers from a first wider channel on the free face surface towards to a first narrower channel, wherein the walls of the first conical channel form a first angle (α) with the vertical plane.

9. The laminated product processing method according to claim 8, wherein the first angle (α) varies between 1° and 70°.

10. The laminated product processing method according to claim 5, wherein in the second step a second beam travels along the cutting line in a translation movement that coincides with the cutting path in the center of the first conical channel, with a second translation speed and a second laser beam power, combined in order to cut the second element.

11. The laminated product processing method according to claim 8, wherein in the second step a second conical channel or conical housing is opened in the second element, which tapers from a second wider channel on the surface of the coupling face to a second narrower channel, wherein the second conical channel forms a second angle (β) with the vertical plane.

12. The laminated product processing method according to claim 11, wherein the second angle (β) is smaller than the first angle (α).

13. The laminated product processing method according claim 5, wherein the power of the first beam of the first step corresponds to a value between 30% and 70% of the power of the second beam, and the speed of the second beam corresponds to a value between 30% and 70% of the speed of the first beam.

14. A cut product, obtained from a laminated product, according to claim 1, processed by a method comprising at least a first step of lowering the first element and at least a second step of cutting the second element, performed with the same laser equipment.

15. A use of a cut product according to claim 14, in objects for decoration, collage, crafts, books, notebooks, albums, binders, furniture industries, and/or textiles.

16. A computer-readable memory, wherein said memory comprises a set of instructions that, when executed, carry out the laminated product processing method of claim 5.

17. The laminated product processing method according to claim 9, wherein the first angle (α) varies between 15° and 45°.

18. The laminated product processing method according claim 13, wherein the power of the first beam of the first step corresponds to a value between 40% and 60% of the power of the second beam, and the speed of the second beam corresponds to a value between 40% and 60% of the speed of the first beam.
